(19) United States
(12) Patent Application Publication
(10) Pub. No.: US 2015/0087438 A1
(43) Pub. Date: Mar. 26, 2015

(54) DUAL PROCESS GOLF CLUB COMPONENT

(71) Applicant: Cobra Golf Incorporated, Carlsbad, CA (US)

(72) Inventors: Matthew R. Johnson, San Marcos, CA (US); Michael S. Yagley, Carlsbad, CA (US)

(73) Assignee: COBRA GOLF INCORPORATED, Carlsbad, CA (US)

(21) Appl. No.: 14/035,176

(22) Filed: Sep. 24, 2013

(51) Int. Cl. A63B 53/04; B23H 5/00; B23H 1/00

(52) U.S. Cl. CPC A63B 53/047; B23H 1/00; B23H 5/00; A63B 2053/0479; A63B 2053/0445
USPC 473/331; 219/69.11

(57) ABSTRACT

The invention provides methods of making a component for a golf club by shaping a workpiece by a first process and also shaping the workpiece by a second process that includes electrical discharge machining. A first process such as forging or casting can shape the gross morphology of the workpiece and material can be removed by the second process to form desired features or textures. In certain aspects, the invention provides a golf club head with a club head body having a face, a sole, a toe, a heel, and a hosel extending upwards from a heel-side of the club head body when the club head is at address. A part of the club head body is formed by the first process, with material having been removed from the part by the second process.

### FIELD OF THE INVENTION

The invention generally relates to methods of making golf club components that include an electrical and a non-electrical process and clubs that include those components.

### BACKGROUND

Golfers want golf clubs that give them the power to control the golf ball. For example, if a golfer can get enough spin, they can make a golf ball land on the green and roll backwards into the hole. To this end, golf clubs have grooves or score lines that impart spin and can aid in other benefits such as channeling water.

One possible way to form a club face is electrical discharge machining, which involves using an electrode to flow current across a dielectric between the electrode and the workpiece to remove material. For example, U.S. Pat. No. 4,964,641 to Miesch, U.S. Pub. 2012/0071269 to Rahrig, and U.S. Pub. 2002/0025861 to Ezawa each report a club face with electrical discharge machined features and U.S. Pub. 2013/0072321 to Morales mentions machining a cell lattice for a golf club by electrical discharge machining.

Unfortunately, electrical discharge machining requires time and expense. The dielectric fluid must be washed and replaced between each pulse of current and some parts and materials of the instruments are consumables that must be re-supplied with regular usage. Electrical discharge machining has shortcomings that relate to the finished product, as well. Electrical discharge machining gives little control over intrinsic material properties such as grain or hardness. Also, electrical discharge machining is associated with a characteristic re-solidified “white zone” overlaying a re-hardened layer on the surface of the workpiece. These layers may include undesirable martensite, crystals that guide fracturing, or stress risers.

### SUMMARY

The invention provides methods of making a component for a golf club by shaping a workpiece by one process and also shaping the workpiece by electrical discharge machining. A process such as forging or casting can shape the gross morphology of the workpiece and material can be removed by an electrical process to form desired features or textures. Since the piece is not formed entirely by electrical discharge machining, a designer has control over intrinsic properties of the workpiece material and surface. For example, metal grain can be influenced by forging, or high stress areas of a club head—such as a face-sole transition—can be formed without electrical discharge machining if it is desired to exclude the martensite or re-hardened layer from those parts of the club head. The components can be made rapidly with low costs by shaping the workpieces with a non-electrical process and rapidly performing electrical discharge machining only on desired areas (e.g., grooves can be stamped into face inserts and surface texture applied electrically). Thus a golf club component can benefit from electrical discharge machining in a production method that can be rapid and affordable while giving designers control over material properties.

In certain aspects, the invention provides a method of making a component for a golf club head. The method includes obtaining a workpiece comprising a material such as a metal, forming the workpiece by a first process, and removing material from the workpiece by a second process. The second process includes using an electrode to flow a current across a dielectric separating the workpiece from the electrode. The workpiece is used in making a golf club.

The first process may be casting, forging, stamping, or machining. Forming the workpiece by the first process may include introducing grooves into the ball-striking face or otherwise shaping the workpiece with a result that at least a portion of a surface of the workpiece deviates from a plane. The second process may provide a surface texture on the grooves. The second process can form dimples, holes into a surface of the component, or other hard-to-form features. The first and second process can be performed in any order, simultaneously (precisely or overlapping), or in an alternating pattern.

In some embodiments, the workpiece provides a ball-striking face of the golf club head. In certain embodiments, the golf club head is a wedge-style club head.

In related aspects, the invention provides a golf club head with a club head body having a face, a sole, a toe, a heel, and a hosel extending upwards from a heel-side of the club head body when the club head is at address. A part of the club head body is formed by a first process, with material having been removed from the part by a second process that includes using an electrode to flow a current across a dielectric separating a workpiece from the electrode.

### BRIEF DESCRIPTION OF THE DRAWINGS

FIG. 1 diagrams a method of making a component for a golf club head.

FIG. 2A shows a front view of a club head.

FIG. 2B shows an oblique view of the club head of FIG. 2A.

FIG. 3 gives a diagram of a method of the invention.

FIG. 4 presents a method of making a component according to some embodiments.

FIG. 5 shows a method according to certain embodiments.

FIG. 6 depicts methods of embodiments of the invention.

FIG. 7 illustrates methods of certain embodiments.

FIG. 8 presents methods of the invention.

FIG. 9 shows a method of making a component according to some embodiments.

FIG. 10 illustrates assembly of a component into a club head.

FIG. 11 gives a front view of a club head of certain embodiments.

FIG. 12A shows components of a club head.

FIG. 12B is a cross-section of a club head with the components of FIG. 12A.

FIG. 13 is a front view of a club head of some embodiments.

FIG. 14 illustrates a component of a golf club head.

FIG. 15 is a cross-sectional view of a component of some embodiments.

FIG. 16 is a cross-sectional according to some embodiments.

FIG. 17 gives a cross-sectional view of a component of certain embodiments.

### DETAILED DESCRIPTION

The invention provides methods for making a part for a golf club head. Methods of the invention include forming the part by a first process and a second process, where one of the processes includes electrical discharge machining (EDM).

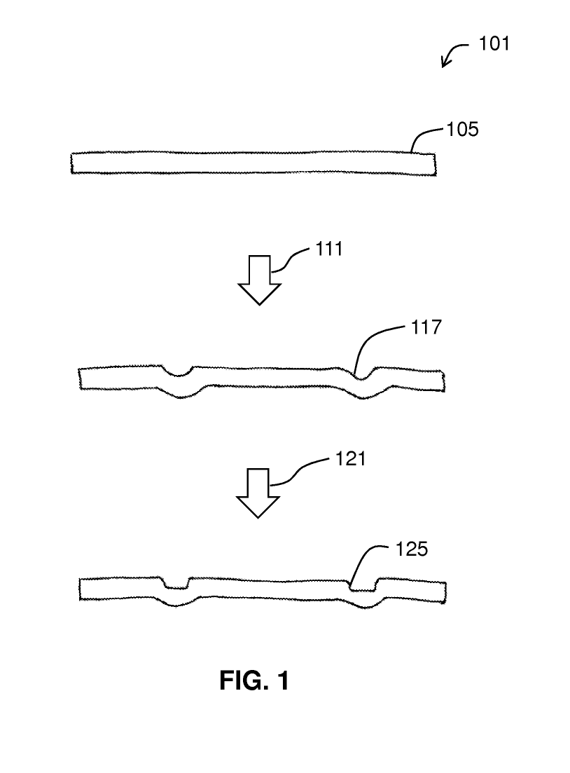

FIG. 1 diagrams a method 101 of making a component for a golf club head. A workpiece 105 is obtained that includes a desired material. Any suitable material can be used. Suitable materials may include metals such as steel, titanium and titanium alloys, aluminum and aluminum alloys, magnesium and magnesium alloys, tungsten, one or more composite materials, others, or combinations thereof. Workpiece 105 is then formed by first process 111 such that workpiece 105 includes a feature 117 such as a groove. Any suitable process can be used in first process 111 such as, for example, stamping, forging, casting, machining, others, or combinations thereof. Material is then removed from workpiece 105 by a second process 121. Preferably, the second process 121 includes using an electrode to flow a current across a dielectric separating the workpiece from the electrode. First process 111 and second process 121 may be performed in any order, simultaneously, overlapping, alternating, or with any suitable scheduling. First process 111 and second process 121, and any other processes that may be included, are thus used to form the workpiece into a component for a golf club head. In some embodiments, methods of the invention then also include making a golf club head that includes the component.

Second process 121 may be accomplished by EDM. EDM, sometimes colloquially also referred to as spark machining, spark eroding, burning, die sinking or wire erosion, is a manufacturing process whereby workpiece 105 is shaped using electrical discharges (sparks). Material may be removed from workpiece 105 by a series of rapidly recurring current discharges between two electrodes, separated by a dielectric liquid and subject to an electric voltage. One of the electrodes is called the tool-electrode, or simply the ‘tool’ or ‘electrode’, while the other is called the workpiece-electrode, or ‘workpiece’ and is provided by workpiece 105.

When the distance between the two electrodes is reduced, the intensity of the electric field in the volume between the electrodes becomes greater than the strength of the dielectric, which breaks, allowing current to flow between the two electrodes. As a result, material is removed from both the electrodes. Once the current flow stops, new liquid dielectric may be conveyed into the inter-electrode volume enabling the solid particles (debris) to be carried away and the insulating properties of the dielectric to be restored. Adding new liquid dielectric in the inter-electrode volume is commonly referred to as flushing. Also, after a current flow, a difference of potential between the two electrodes is restored to what it was before the breakdown, so that a new liquid dielectric breakdown can occur.

There may be different approaches to EDM such as, for example, wire EDM and die-sink EDM. In wire EDM, a continuously replaced wire is used as an electrode. In die-sink EDM, a set of electrodes having different sizes, shapes, etc. may be used during the same EDM operation in order to obtain a desired feature. In die-sink EDM, the electrode may mimic a negative of a desired shape of the part. The electrode may be advanced toward the part along a single direction (e.g., along the z-axis). The electrode used in die-sink EDM may have complex geometries. Thus EDM is a method of removing material from workpiece 105 by using a tool electrode. EDM may be referred to variously as sinker EDM, cavity type EDM, cavity EDM, volume EDM, spark machining, spark eroding, spark burning, die sinking, or wire erosion, any of which may be suitable for inclusion in second process 121. EDM may be found discussed in U.S. Pat. No. 6,979,795 to Kaneko; U.S. Pat. No. 6,403,910 to Stang; U.S. Pat. No. 4,310,742 to Pfau; U.S. Pat. No. 4,114,015 to Vasiliev; U.S. Pat. No. 3,814,893 to Helms; U.S. Pat. No. 3,614,372 to Dulebohn; and U.S. Pub. 2002/0096497 to Jariabek, the contents of which are incorporated by reference. Any suitable instrument may be used for EDM. An exemplary instrument is the Sodick AP3L Sinker EDM Machine sold by ACI Machine Tool Sales, LLC (Lawrenceburg, Ky.).

In some embodiments, method 101 includes using first process 111 to “rough in” groove 117 on workpiece 105 as shown in FIG. 1. First process 111 may include a non-electrical process such as casting or forging. This gives the gross morphology of a final component of a club head, such as a face of the club head with a ball-striking face on one surface. With the grooves 117 roughed in, workpiece 105 is then finished by second process 121 (e.g., an electrical process such as EDM, electrical meaning that the application of charge, current, or electrical field E directly to workpiece 105 is the primary direct cause of shaping or forming workpiece 105). Finishing by EDM gives a club designer excellent control of surface finishes or texture and over fine morphological details such as radii of internal or external curvature of edges 125 of grooves 117, as shown in FIG. 1.

Since EDM is used in second process 121, steps such as milling, cutting grooves, laser cutting marks, or even sand blasting can be avoided, if that is desired. It may be found that such steps introduce stress risers to a greater degree than EDM and thus the effects of those stress risers is inhibited by use of EDM for finishing. It will be appreciated that stress risers include locations where stress is concentrated and can be associated with cracks including very fine cracks or fissures.

Since EDM is used second process 121, it may found that method 101 provides for the rapid machining of unique surface geometries that cannot be done (rapidly or at all) with conventional casting, forging, or machining techniques alone.

Since EDM is used second process 121, it may found that method 101 provides control over surface roughness of a golf club ball-striking face to create more (or less) ball-face friction in very precise locations on the club head.

Additionally, EDM provides a finely-tuned tool for material removal for weight distribution. For example, after forming workpiece 105 into a face component for a club head, using first process 111 to create grooves 117, then second process 121 can be used to remove pockets of material from the back of the face piece. If material is removed from the top-center area of the back, the effect will be to distribute mass of the club head down and towards the perimeter, which lowers a club head center of gravity and increases a moment of inertia about an axis that is vertical when the club head is address. Weight removal patterns that can be accomplished by methods of the invention are shown in SELECTIVELY DECONSTRUCTED COMPONENT FOR GOLF CLUBS, U.S. patent application Ser. No. 13/489,154 to Beno, et al., filed Jun. 5, 2012.

Further, use of EDM provides a technique for providing mounting features such as ledges, feet, “tangs”, bendable tabs that deform to hold the face in a club head body, or other features. Such features may be found discussed in U.S. Pat. No. 8,491,412 to Roach (see, e.g., FIGS. 16 and 17 therein) and U.S. Pat. No. 8,485,918 to Roach.

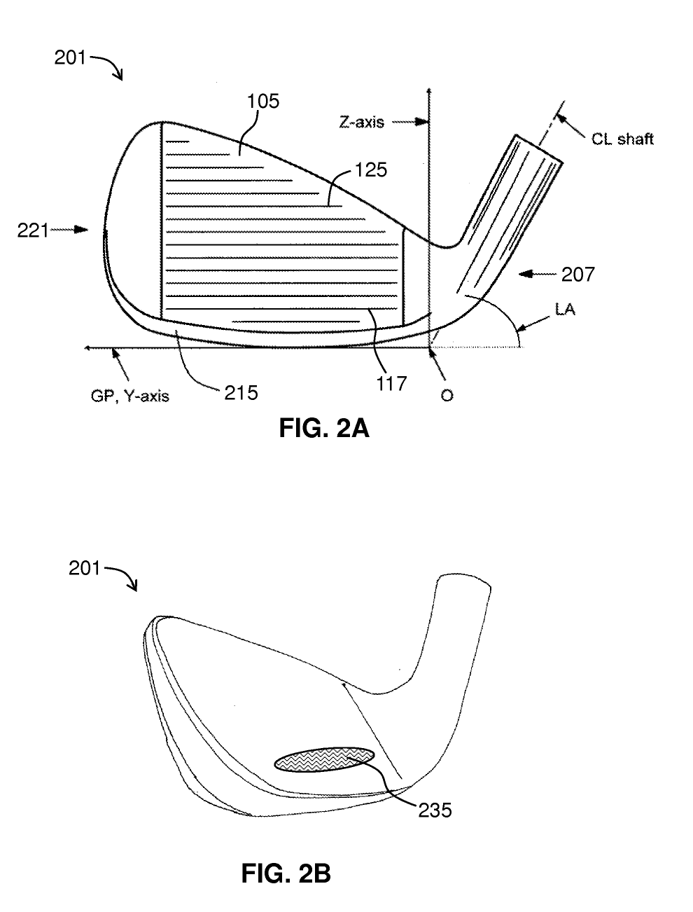

FIG. 2A shows a front view of a club head 201 according to some embodiments. Club head 201 includes workpiece 105 providing a face insert with a ball striking face. Edges 125 of grooves 117 are included, having been formed by first process 111 and second process 121. Club head 201 includes a heel side 207 with a hosel and a toe side 221 on opposed ends of a sole portion 215. FIG. 2A shows club head 201 in an address position on ground plane GP, with a Y-axis and a Z-axis drawn in defining an origin O. An extension of the centerline CL of the golf club shaft is drawn in to illustrate a lie angle LA. Origin O is defined by an intersection of CL and GP. Y axis extends substantially parallel to grooves 117. The Y-axis, Z-axis, and X-axis (not pictured) are all orthogonal to one another.

One beneficial application of the invention is to provide a club head in which EDM is used to create desired features but not used in those portions of a club head that are subject to maximum stress. For example, it may be desired to have a club head with a ball-striking face in which grooves 117 include edges 125 that are textured by EDM. However, it may be found that certain zones of a club head are subject to maximum stress during use.

FIG. 2B shows club head 201 with zone 235 of maximal stress called out (the oval is drawn in the figure for illustrative purposes but need not appear as an oval on a club head). It may be found that an area just near where a ball-striking face transitions to sole 215 is the area subjected to maximal stress during usage. This is discussed in MULTI-MATERIAL GOLF CLUB HEAD, U.S. patent application Ser. No. 13/922,754 to Roach, filed Jun. 20, 2013. A club designer may wish to avoid using EDM in zone 235 but may desire to have grooves 117 appear both within, and outside of, zone 235 on finished club head 201. It may be found that EDM introduces martensite or crystalline hardened portions that seed and guide cracks or fissures. Not performing EDM in zone 235 may provide the most durable club head by not providing any adverse features at which fissures or cracks may develop. Since first process 111 forms grooves 117 across all of the ball-striking face, EDM need to be performed in zone 235. This may be accomplished by using an EDM instrument operated or controlled via computer-numeric control (CNC), discussed in more detail below.

Methods of the invention can be used to provide a golf club component with any of a variety of features.

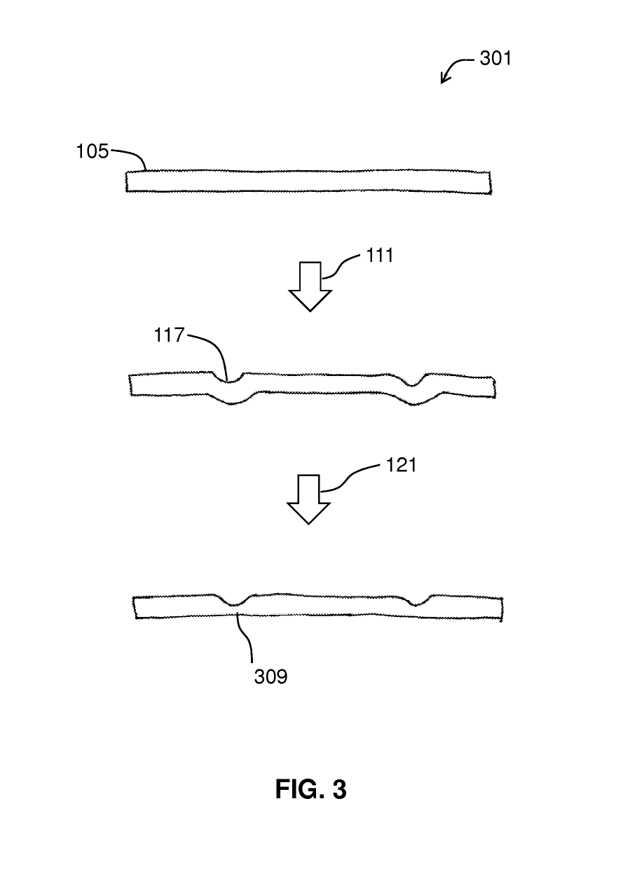

FIG. 3 illustrates use of a method 301 to provide a workpiece 105 that includes grooves 117 and a flat back 309. Here, first process 111 is used to add grooves 117 to workpiece 105. First process 111 may be, for example, stamping or forging. It may be most beneficial to use a non-electrical process for first process 111 because it may be most desirable to use a process that influences intrinsic properties of workpiece (such as grain or hardness) in ways that EDM does not. As shown in FIG. 3, once grooves 117 are added, back 309 is made flat via EDM.

Methods of the invention can thus be used to form desired features such as to shape edges, form grooves, flatten features (e.g., to provide a flat front or back), give textures, avoid stress risers in high stress zones. Methods of the invention can be used to create other features and shapes such as face with curves to provide, for example, bulge or roll. Methods of the invention can be used to produce one or more roll radii such as, for example, a club head such as may be found described in GOLF CLUB HEAD WITH OPTIMIZED MOI AND/OR ROLL RADIUS, U.S. Pub. 2013/0029780 to Beno, the contents of which are incorporated by reference.

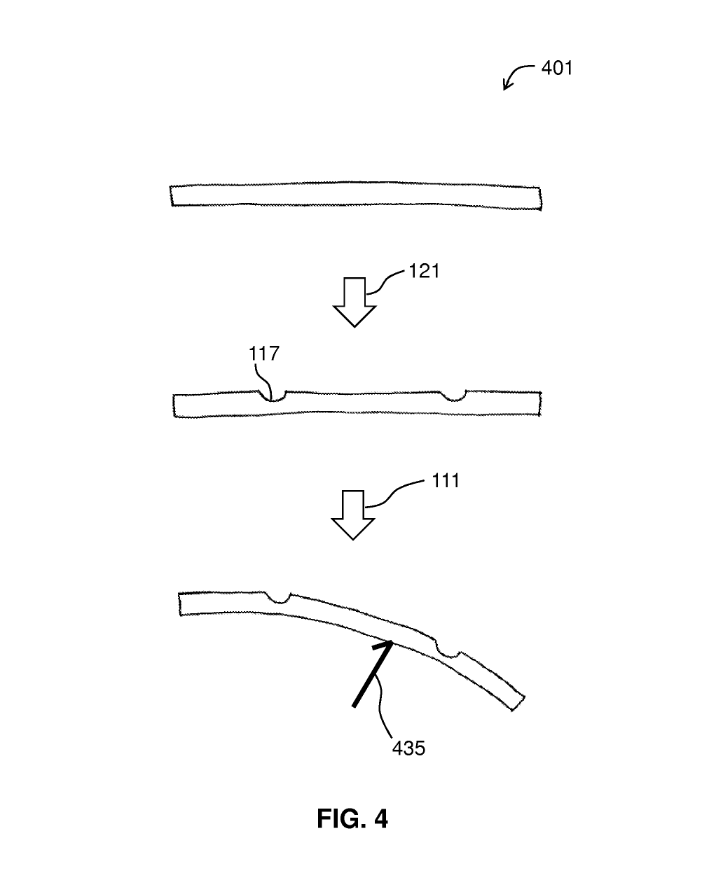

FIG. 4 presents a method 401 of making a component to include a roll radius 435. Here, second process 121 (e.g., an electrical process such as EDM) is used on workpiece 105 to produce grooves 117. First process (e.g., a non-electrical process such as forging) is used to produce roll radius 435. In related embodiments, the invention provides other methods for forming curved features such as roll radii.

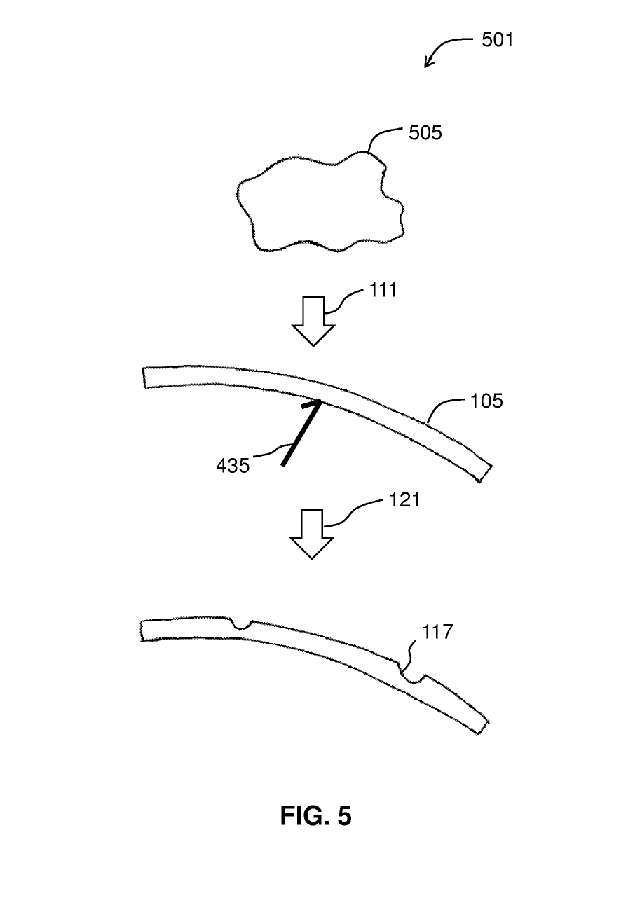

FIG. 5 shows a method 501 for producing a component that includes a roll radii 435. Here, raw material 505 is shaped by first process 111 (e.g., a non-electrical process such as casting or forging). Second process 121 (e.g., an electrical process such as EDM) is used on workpiece 105 to produce grooves 117.

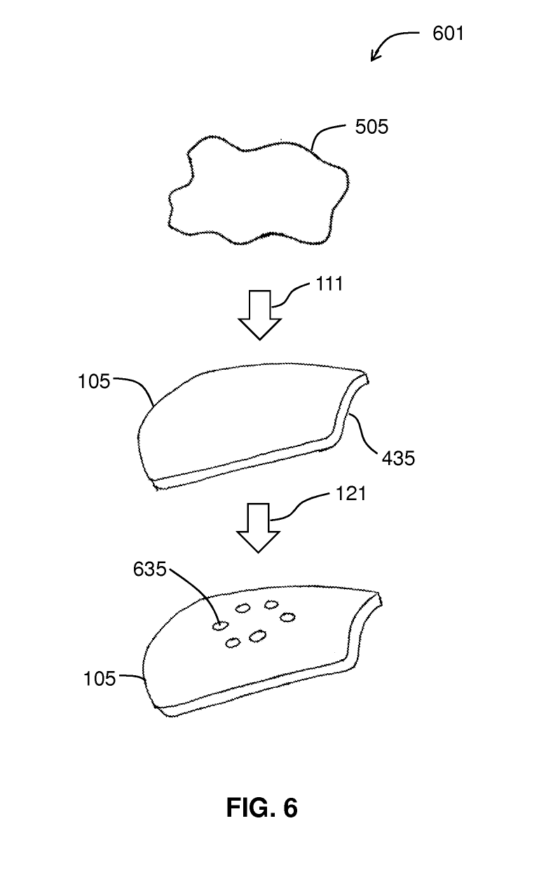

FIG. 6 depicts a method 601 for producing a component that includes a roll radii 435. Here, raw material 505 is shaped by first process 111 (e.g., a non-electrical process such as casting or forging). Second process 121 (e.g., an electrical process such as EDM) is used on workpiece 105 to produce punches 635. It will be appreciated that punches into a material such a metal are difficult or expensive to produce by existing non-electrical processes. It may desired to include punches 635 in the form of pockets or dimples into a surface of a material. It may be found that EDM is an ideal process for forming punches 635 yet that EDM is not well-suited for adding a roll radius to a workpiece 105. Method 601 provides a way to include both punches 635 and roll radius 435 via a process that may be found to be rapid and affordable.

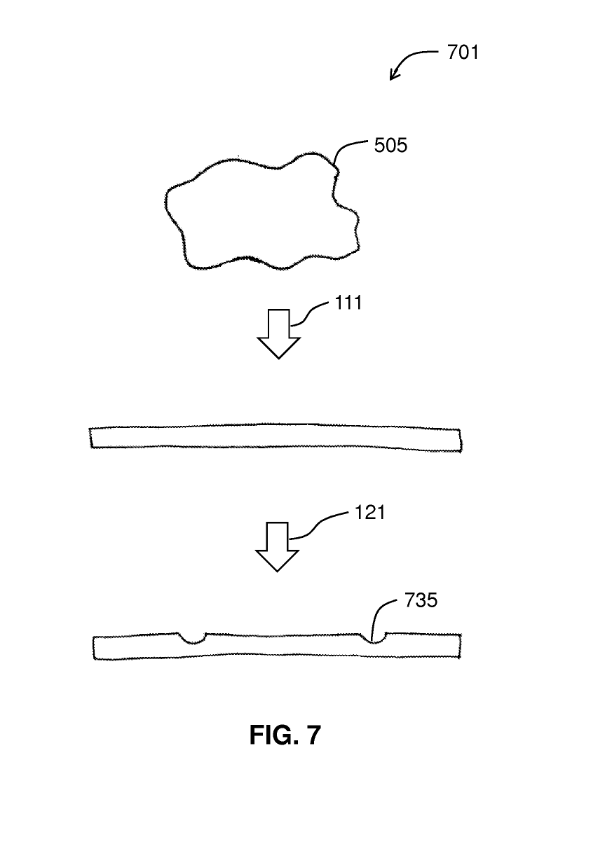

FIG. 7 illustrates a method 701 that includes using first process 111 (e.g., forging or casting) to form workpiece 105 and second process 121 to add features 735, which may be dimples, grooves, punches, channels, score lines, embossing, graphics, logos, or any other feature.

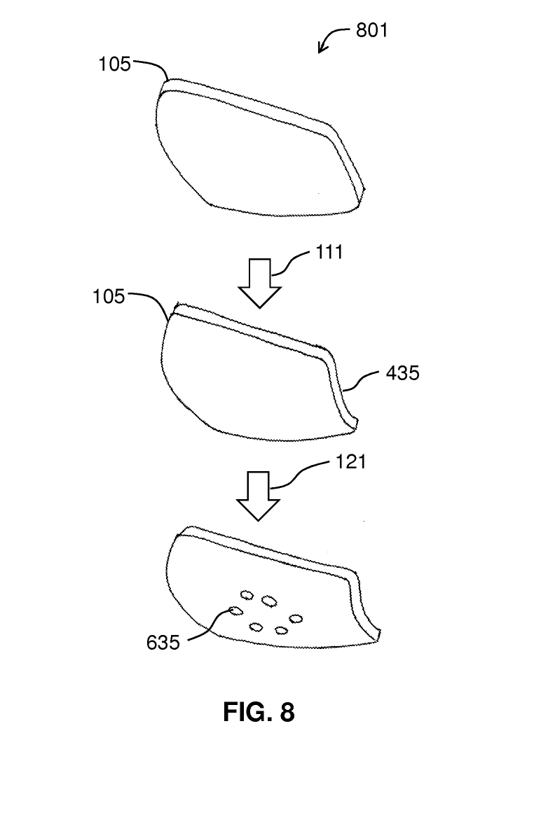

FIG. 8 gives a method 801 for adding roll radius 435 to workpiece 105 by first process 105 (e.g., by forging or bending). Second process 121 is used to add punches 635 to produce a finished component for a club head.

In some embodiments, methods of the invention are used to introduce combinations of features (e.g., grooves and punches) to a component for a golf club head. For example, it may be found that one machining process is well-suited to introducing grooves or score lines, but not well-suited to introducing punches. It may also be found that a combination of grooves and punches provides the best surface finish for a golf club head.

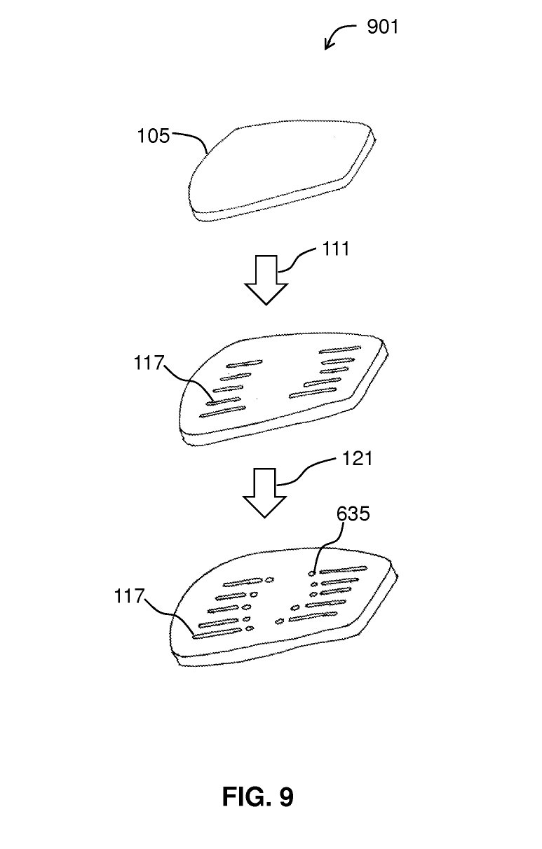

FIG. 9 shows a method 901 for creating a component for a golf club head that includes a combination of features. First process 111 is used to introduce a feature such as grooves 117 to workpiece 105. Second process 121 is used to introduce another feature such as punches 635 to workpiece 105. First process 111 and second process 121 may be performed in any order.

First process 111 may include milling, machining, or any other suitable process. Milling is a mechanical process of using rotary cutters to remove material from a workpiece as it is advanced in a direction at an angle with the axis of the tool. In general, milling operates on the principle of rotary motion. A milling cutter is spun about an axis while a workpiece is advanced through it in such a way that the blades of the cutter are able to shave chips of material with each pass. Milling processes make many individual cuts on the material in a single run using a cutter with many teeth. The number of density of teeth is characterized as pitch. The cutter is spun at high speed, and material generally advances through the cutter slowly. The speed at which the piece advances through the cutter may be called the feed rate. It may be preferable to use a vertical mill.

In a vertical mill, the spindle axis is vertically oriented. A milling cutter is held in the spindle and rotates on an axis of the spindle. The spindle can generally be extended (or the table can be raised/lowered, giving the same effect), allowing plunge cuts and drilling. There are two subcategories of vertical mills: the bed mill and the turret mill. A turret mill has a stationary spindle and the table is moved both perpendicular and parallel to the spindle axis to accomplish cutting. Turret mills may have a quill which allows the milling cutter to be raised and lowered in a manner similar to a drill press. This type of machine provides two methods of cutting in the vertical (Z) direction: by raising or lowering the quill, and by moving the knee. In the bed mill, the table moves perpendicular to the axis of the spindle, while the spindle itself moves parallel to its own axis. Typically, larger milling machines are of the bed type and may be operated by a computerized control system. While one of skill in the art will understand that any of a number of suitable milling machines may be used, an exemplary such machine is the Vertical Machining Center sold as Model VF-2 by Haas Automation, Inc. (Oxnard, Calif.).

In practice, workpiece 105 is loaded into the milling machine. Workpiece 105 includes a material selected for inclusion in the final golf club component. Any suitable material may be used to make a golf club component including metals, polymers, composites, and other materials. Examples in include steel, aluminum, titanium, alloys, plastics, carbon fiber, or any other material. In certain embodiments, a golf club component includes 303 stainless steel.

Using a tooling or milling machine, the computer program is selected and the machine is set to operate. Workpiece 105 is loaded into the mill, which is programmed according to the manufacturer's instructions. The machine spindle spins the milling cutter while the table advances the workpiece material through the cutting area. As material passes through the cutting area of a milling machine, the blades of the cutter take swarfs of material at regular intervals. The cutting operation produces revolution marks and cuts into the material creating the grooves 117. This may be included in first process 111. Milling and machining suitable for use in first process 111 are discussed in MILLING PROCESS FOR ROUGHNESS OF GOLF CLUB FACE, U.S. Provisional Patent Application Ser. No. 61/864,925 to Moreira, filed Aug. 12, 2013.

First process 111 or second process 121 may include use of a machine (e.g., for milling or EDM) capable of automation through the use of programmed commands encoded on a non-transitory storage medium, also known as computer numeric control. Numerical control (NC) is the automation of machine tools that are operated by programmed commands encoded on a storage medium, as opposed to controlled manually via hand wheels or levers, or mechanically automated via cams alone. Most NC today is computer numerical control (CNC), in which computers play an integral part of the control. NC or CNC can be used in performing any EDM process described herein.

In modern CNC systems, end-to-end component design may be automated using computer-aided design (CAD) and computer-aided manufacturing (CAM) programs. The programs produce a computer file that is interpreted to extract the commands needed to operate a particular machine via a postprocessor, and then loaded into the CNC machines for production. Since any particular component might require the use of a number of different tools—such as drills, saws, etc.—modern machines often combine multiple tools into a single “cell”.

It will be appreciated that forming a component for a golf club by methods described herein allows for production of customized golf clubs. For example, an EDM process can be operated by CNC and can create customized features on golf club components. In certain aspects, the invention provides methods and systems for creating customized clubs. An order can be received, generated from a customer's use of a computer device to input a custom order. The order may be received at a server computer system comprising a non-transitory memory coupled to a processor. The server computer system may be used in the operation of an EDM system (e.g., via CNC) to perform methods described herein. The EDM system used according to methods described herein can provide a customized club head according to the customer's order. Producing and fulfilling custom orders is discussed in U.S. Pub. 2013/0178306 to Beno and U.S. Pub. 2013/0166405 to Mitzel, the contents of which are incorporated by reference.

A variety of methods of forming a component of a golf club head are introduced. Methods of the invention may include assembling a component with other components to produce a golf club head or finished golf club.

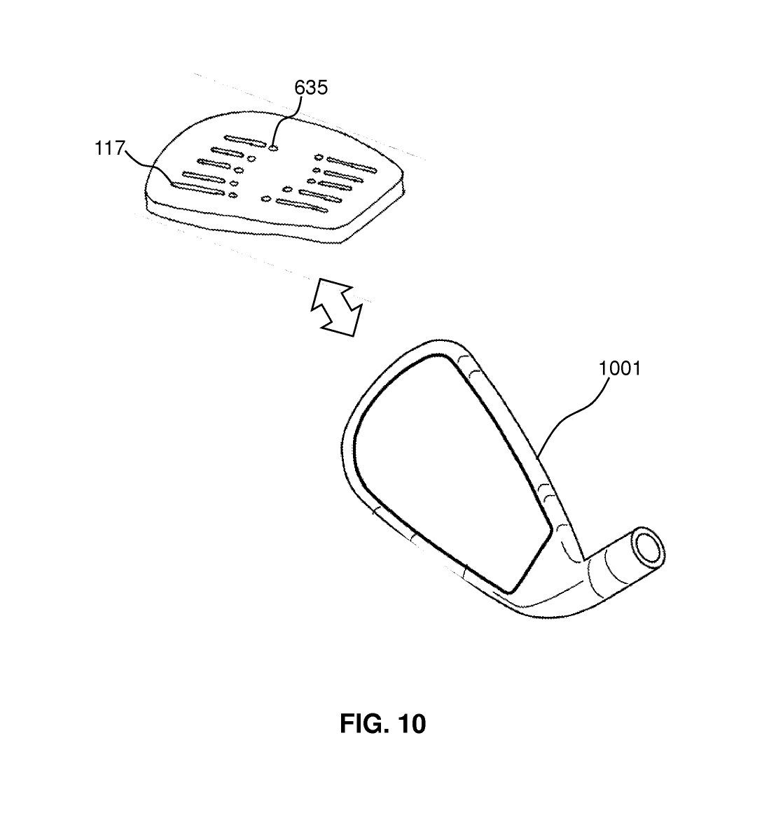

FIG. 10 illustrates assembly of a component into a club head. Here, the component is a face insert to be attached to a club head body 1001. The face insert includes both grooves 117 and punches 635 (although any face insert made by a method of the invention may be used). Club head body 1001 is shown as a single piece forming an overall outside body for a cavity-backed style iron, although any type of club head body may be used and club head body 1001 may itself include multiple components. The face insert is attached to club head body 1001 by any suitable means such as, for example, welding, mechanical fasteners, swaging, press-fit, or others. Exemplary methods of attaching a face insert to a club head are discussed in U.S. Pat. No. 8,491,412; U.S. Pat. No. 8,485,918; U.S. Pat. No. 8,480,512; U.S. Pat. No. 8,172,698; U.S. Pat. No. 7,811,179; U.S. Pat. No. 7,811,180; U.S. Pat. No. 7,588,503; U.S. Pub. 2004/0157677; and U.S. Pub. 2003/0153397, the contents of each of which are incorporated by reference for all purposes.

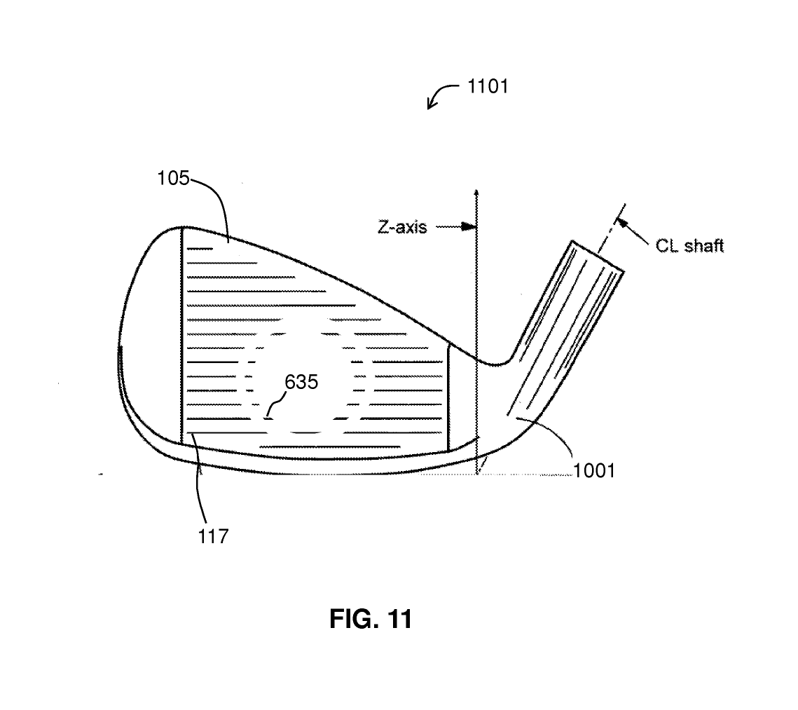

FIG. 11 gives a front view of a club head 1101 made using club head body 1001. The face insert (i.e., workpiece 105) includes both grooves 117 and punches 635 (although any face insert made by a method of the invention may be used).

The component made using methods of the invention need not be a face insert and any component may be made.

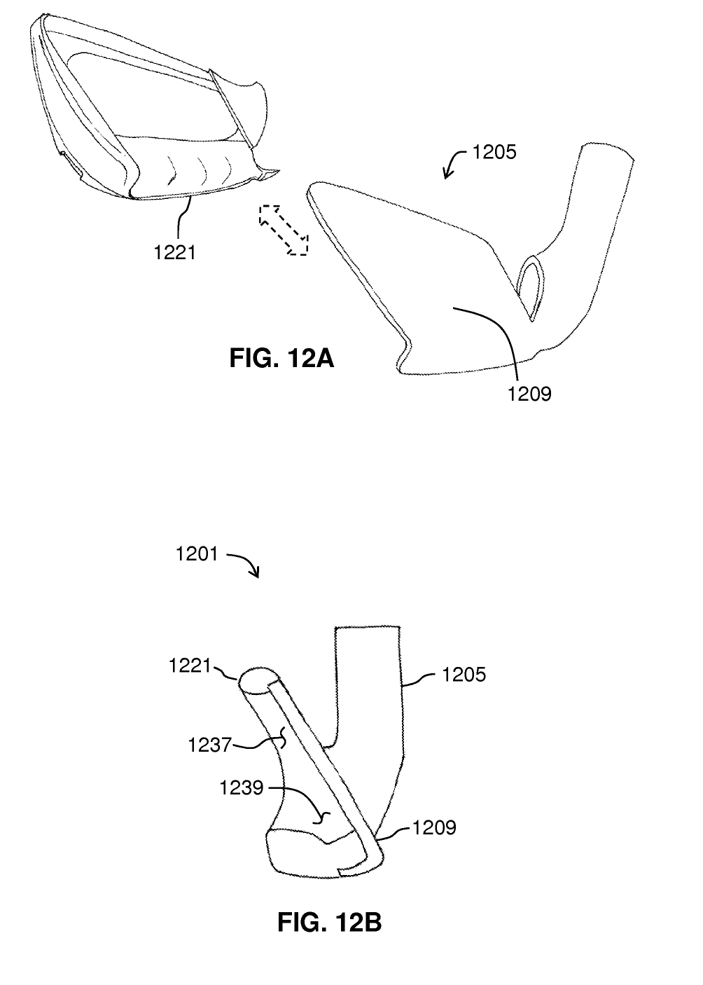

FIG. 12A shows a multi-component club head 1201 of some embodiments in which a first component 1205 is assembled with a second component 1221. First component 1205 has an overall gross morphology formed by first process 111 (e.g., casting or forging). First component 1205 also includes a strike face 1209 with features, such as grooves 117 (not pictured in FIG. 12A) or texture, formed by second process 121 (e.g., an electrical process such as EDM).

FIG. 12B is a cross-section of club head 1201. First component 1205 is assembled with a second component 1221.). First component 1205 also includes a strike face 1209. Club head 1201 includes a cavity 1237 into a back side as well as an optional recess 1239 extending down from cavity 1237.

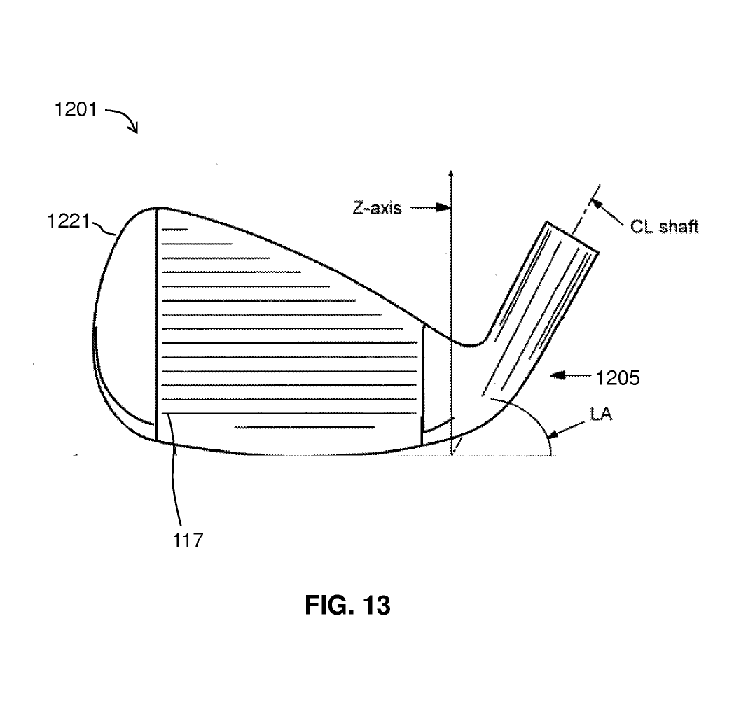

FIG. 13 is a front view of club head 1201, showing second component 1221 mated with first component 1205 having grooves 117 on the ball-striking face. While shown here as including grooves 117 produced by EDM, it will be appreciated that EDM may be used to provide other features such as punches.

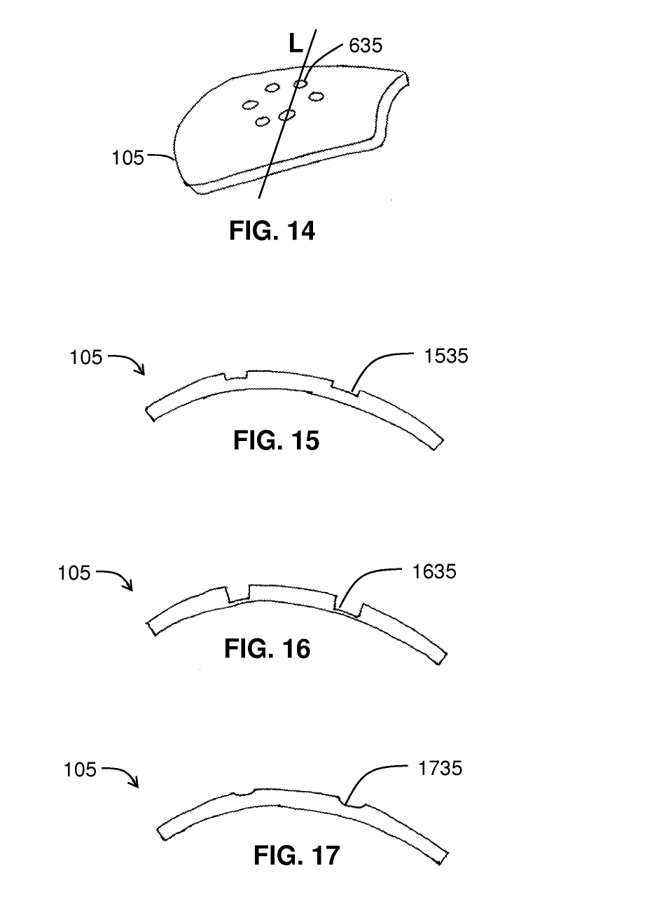

FIG. 14 illustrates a component 105 for a golf club head bearing punches 635. Punches 635 may have any suitable shape such as cutaways, depressions, dimples, pockets, voids, apertures or holes through the piece, others, or a combination thereof. Punches 635 may include interior surfaces that are smooth, textured, irregular, or shaped (e.g., star-shaped punches). Line L shows a useful idealized line from which a cross-sectional view could be derived.

FIG. 15 gives a cross-sectional view of a component according to certain embodiments in which shallow punches 1535 have been formed in the component by methods of the invention. Shallow punches 1535 may generally be characterized by a cylindrical shape with a diameter greater than depth.

FIG. 16 gives a cross-sectional view of a component according to certain embodiments in which punches 1635 have been formed in the component. Punches 1635 may generally be characterized by a cylindrical shape with a diameter generally smaller than or equal to depth.

FIG. 17 gives a cross-sectional view of a component according to certain embodiments in which dimples 1735 have been formed in the component. Dimples 1735 may generally have morphology similar to the dimples seen on a golf ball.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method of making a component for a golf club head, the method comprising:
obtaining a workpiece comprising a material;
forming the workpiece by a first process;
removing material from the workpiece by a second process that includes using an electrode to flow a current across a dielectric separating the workpiece from the electrode; and
making a golf club head that includes the workpiece.

2. The method of claim 1, wherein the first process comprises one selected from the list consisting of casting, forging, stamping, and machining.

3. The method of claim 1, wherein the workpiece provides a ball-striking face of the golf club head.

4. The method of claim 3, wherein the golf club head is a wedge-style club head.

5. The method of claim 3, wherein the forming the workpiece introduces grooves into the ball-striking face.

6. The method of claim 5, wherein the second process provides a surface texture on the grooves.

7. The method of claim 1, wherein removing the material produces dimples on a surface of the workpiece.

8. The method of claim 1, wherein removing the material produces holes into a surface of the workpiece.

9. The method of claim 1, wherein forming the workpiece comprises shaping the workpiece with a result that at least a portion of a surface of the workpiece deviates from a plane.

10. The method of claim 1, wherein the first process is performed prior to the second process.

11. A golf club head comprising:
a club head body comprising a face, a sole, a toe, a heel; and
a hosel extending upwards from a heel-side of the club head body when the club head is at address, wherein a portion of the club head body is formed by a first process, with material removed by a second process that includes using an electrode to flow a current across a dielectric separating a workpiece from the electrode.

12. The club head of claim 11, wherein the first process comprises one selected from the list consisting of casting, forging, stamping, and machining.

13. The club head of claim 11, wherein the portion of the club head body comprises a ball-striking face of the golf club head.

14. The club head of claim 13, wherein the golf club head is a wedge-style club head.

15. The club head of claim 13, wherein the forming the first process is not electrical discharge machining.

16. The club head of claim 15, wherein the first process creates grooves and the second process provides a surface finish for the grooves.

17. The club head of claim 11, comprising a dimpled surface.

18. The club head of claim 11, comprising holes into a surface of the club head.

19. The club head of claim 11, wherein the first process introduces a roll radius.

20. The club head of claim 11, wherein the second process is performed prior to the first process.
